(19) United States
(12) Patent Application Publication
(10) Pub. No.: US 2009/0221274 A1
(43) Pub. Date: Sep. 3, 2009

(54) SYSTEM, METHOD AND DEVICE FOR ENABLING ALTERNATIVE CALL HANDLING ROUTINES FOR INCOMING CALLS

(76) Inventors: Poornima VENKATAKRISHNAN, San Jose, CA (US); Ted Dorff, Santa Clara, CA (US)

Correspondence Address: SHEMWELL MAHAMEDI LLP, 4880 STEVENS CREEK BOULEVARD, SUITE 201, SAN JOSE, CA, 95129-1034, US

(21) Appl. No.: 12/040,529

(22) Filed: Feb. 29, 2008

(51) Int. Cl. H04M 3/42

(52) U.S. Cl. 455/417

(57) ABSTRACT

An incoming call is received on a computing device. In response to receiving the call, a determination is made to implement an alternative call handling routine instead of a default call handling routine. The alternative call handling routine is then initiated by performing a set or sequence of one or more actions that comprise the alternative call handling routine.

### TECHNICAL FIELD

The disclosed embodiments relate to a system, method and device for enabling alternative call handling routines for incoming calls.

### BACKGROUND

Computing devices, particularly handheld and portable devices, have evolved to include numerous types of communication capabilities and functionality. For example, handheld devices exist that operate as cellular phones, messaging terminals, Internet devices, while including personal information management (PIM) software and photo-management applications. Additionally, Internet Protocol services exist that can transform Internet-enabled machines into telephony devices. Even stand-alone telephones that connect to traditional Public Switched Telephone Networks (PSTN) are including more software to enhance the telephone's functionality.

In enhancing communication capabilities and functionality, effort has been made to enhance and assist the user in using such devices. For example, software features exist to facilitate the ease in which the user can act on a phone number in an email message. A sequence of phone numbers can be presented to a user for selection, and upon such selection being made, a telephony application may use the selection to place a phone call. Small form-factor computing devices, such as devices that provide cellular phone functionality, have particular use for such short-cut functionality, in order to reduce the manual involvement of the user. These devices have smaller keyboards that may be harder to operate, and/or use in mobile or dynamic environments, where the user cannot readily retrieve a desired number.

Telephony devices are just one type of communication device. There are now many types of communication types, and multi-functional devices exist to accommodate the different communication types. Examples of communication types other than telephony include email, instant message (including SMS protocol messages and Multimedia Message Service (MMS) protocol messages), and video conferencing. Many computing devices, particularly smart phones, are enabled to support communications using multiple communication mediums.

### BRIEF DESCRIPTION OF THE DRAWINGS

FIG. 1 illustrates a method for enabling different call handling routines, under an embodiment.

FIG. 2 illustrates a method for enabling alternative call handling routines to be performed on a device, under an embodiment of the invention.

FIG. 3 compares actions or sequence of actions that may be performed under a default call handling routine, a device-based alternative call handling routine, and a service-based alternative call handling routine, under one or more embodiments of the invention.

FIG. 4 illustrates a computing device configuration for enabling an alternative call handling routine such as described with any of the embodiments described herein, according to another embodiment of the invention.

FIG. 5 illustrates a hardware diagram for a mobile computing device that is configured to support any of the embodiments described herein.

FIG. 6A and FIG. 6B illustrate different user-interface features for use with one or more embodiments of the invention.

FIG. 7 illustrates a service configured to implement an alternative call handling routine, under an embodiment.

### DETAILED DESCRIPTION

Embodiments described herein enable a telephony device or service that incorporates functionality to perform an alternative call handling routine for some incoming phone calls on a selective basis. The alternative call handling routine may include actions that are performed on the device to receive and interact with the incoming call. The alternative call handling routine may differ from actions that comprise a default call handling routine (such as routing an incoming call to conventional voicemail).

In one embodiment, the alternative call handling routine is selectively performed based on the source (e.g. identity) of the incoming call. In particular, one or more embodiments enable a user to select personalized call-handling routines for specific individuals or callers. Thus, for example, one embodiment enables a user to select to have incoming phone calls from a spouse or family member handled with an automated personalized greeting for that individual or class of individuals. Other actions, such as recording messages from those individuals and/or automatically terminating the call, may also be incorporated into alternative call handling routines. In another embodiment, the alternative call handling routine is selectively performed based on the occurrence of an event, such as the user providing input to trigger the performance of the alternative call handling routine.

In either case, the alternative call handling routine may be used to automatically or programmatically perform actions that include one or more of the following: (i) answer an incoming call; (ii) play a pre-recorded message for the incoming call (the pre-recorded message may differ than the outgoing message for the default voicemail); (iii) automatically terminate the call. Still further, the actions may include allowing the caller to record a message before terminating the call. As another variation, the actions may include automatically answering a call and placing or keeping the call in a hold-state, with playback of a recorded message that asks the caller to continue holding. Numerous other variations, actions and sequences are described herein.

Among other benefits, embodiments described herein enable users to programmatically select a more convenient or personalized call handling routine for (i) handling calls from select individuals or classes of individuals; or (ii) handling calls during specific events or situations.

One or more embodiments described herein provide for handling an incoming telephony call with one or more alternative call handling routines. In one embodiment, an incoming call is received on a computing device. In response to receiving the call, a determination is made to implement an alternative call handling routine instead of a default call handling routine. The alternative call handling routine is then initiated by performing a set or sequence of one or more actions that comprise the alternative call handling routine.

In another embodiment, when an incoming call is received, information about a source of the incoming call is determined. The information may include, for example, caller-identification information. From the information, the source of the call is determined. A determination may be made that the source of the caller is one of at least a pre-selected set of sources that are designated to receive an alternative call handling routine. Performance of the alternative call handling routine is then initiated. When the alternative call handling routine is initiated, at least one action is performed that is different from any action performed by a default call handling routine that would have otherwise been performed had the source of the incoming call not been one of the pre-selected set.

Still further, an embodiment provides for a computing device that includes one or more communication components and one or more processors. The one or more communication components may be configured to handle telephony communications over one or more networks. The one or more processors may be configured to respond to an incoming call received from over a network by (i) determining whether the incoming call is to receive a default handling routine or an alternative call handling routine; and (ii) responsive to determining that the incoming call is to receive the default handling routine, enabling the incoming call to be answered by a default voicemail function that plays a corresponding default outgoing message. Else, the one or more processors are configured to be responsive to determining that the incoming call is to receive the alternative call handling routine, and then performing at least one action that comprise the alternative call handling routine.

As used herein, a “call handling routine” means a set or sequence of programmatic actions, performed automatically or at the prompting/selection of the user, by which a computing device handles an incoming call. Examples of actions that may comprise a call handling routine include actions of answering a phone call or terminating a phone call. As described herein, call handling routines may include ‘default’ call handling routines or alternative call handling routines'.

As used herein, the terms “programmatic”, “programmatically” or variations thereof mean through execution of code, programming or other logic. A programmatic action may be performed with software, firmware or hardware, and generally without user-intervention, albeit not necessarily automatically, as the action may be manually triggered.

One or more embodiments described herein may be implemented using programmatic elements, often referred to as modules or components, although other names may be used. Such programmatic elements may include a program, a subroutine, a portion of a program, or a software component or a hardware component capable of performing one or more stated tasks or functions. As used herein, a module or component, can exist on a hardware component independently of other modules/components or a module/component can be a shared element or process of other modules/components, programs or machines. A module or component may reside on one machine, such as on a client or on a server, or a module/component may be distributed amongst multiple machines, such as on multiple clients or server machines. Any system described may be implemented in whole or in part on a server, or as part of a network service. Alternatively, a system such as described herein may be implemented on a local computer or terminal, in whole or in part. In either case, implementation of system provided for in this application may require use of memory, processors and network resources (including data ports, and signal lines (optical, electrical etc.), unless stated otherwise.

Embodiments described herein generally require the use of computers, including processing and memory resources. For example, systems described herein may be implemented on a server or network service. Such servers may connect and be used by users over networks such as the Internet, or by a combination of networks, such as cellular networks and the Internet. Alternatively, one or more embodiments described herein may be implemented locally, in whole or in part, on computing machines such as desktops, cellular phones, personal digital assistances or laptop computers. Thus, memory, processing and network resources may all be used in connection with the establishment, use or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown in figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. mobile devices such as cell phones) are all examples of machines and devices that utilize processors, memory, and instructions stored on computer-readable mediums.

Overview

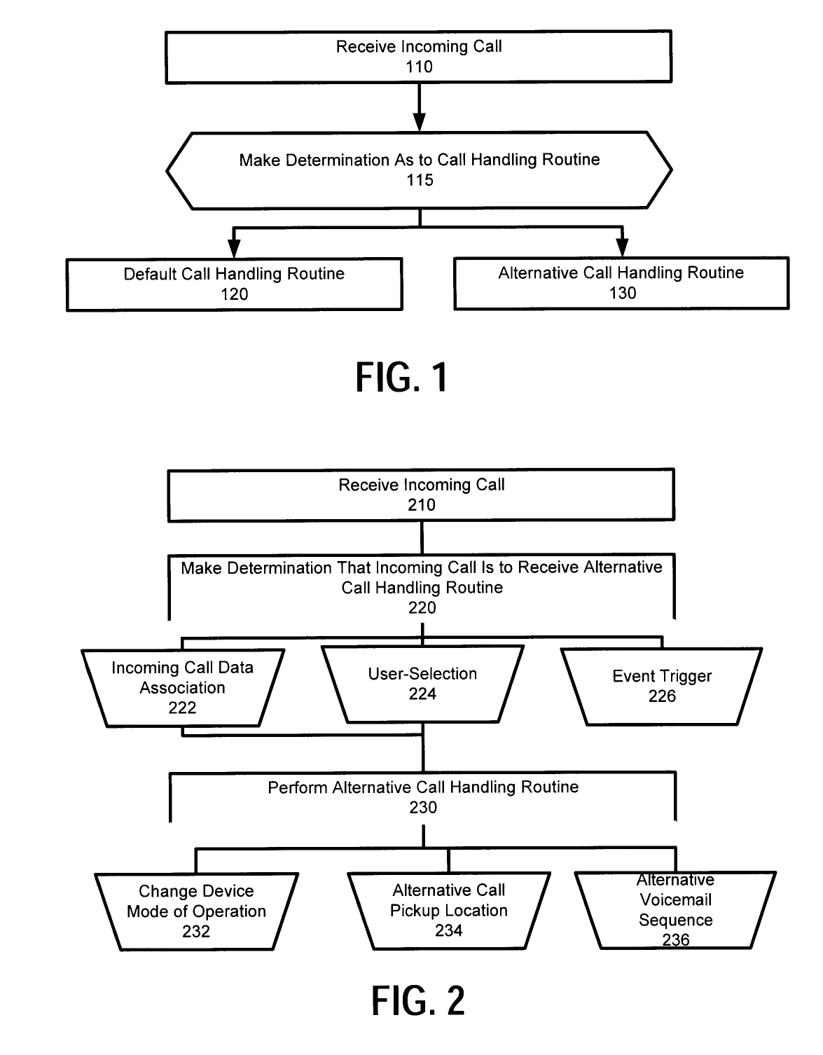

FIG. 1 illustrates a method for enabling different call handling routines for receiving incoming calls on a computing device, under an embodiment. A method such as described may be performed on a telephony device, such as a cellular phone or wireless voice communication device. Alternatively, a method such as described by an embodiment of FIG. 1 may be performed through a service, such as provided by wireless carriers or voice mail providers.

In a 110, an incoming telephony call is received. For example, a cellular device may receive an incoming call that a user of the device may either affirmatively answer or decline. Typically, if the user makes no election to answer or decline the call, the call is eventually transferred into voicemail. Under many conventional approaches, the user's affirmative decision to decline to receive the incoming call results in the call being transferred to voicemail more quickly than the situation where the user neglects to answer the call. When the call is transferred to voicemail, the call is normally transferred to a service. Thus, the voicemail is typically an off-device feature. In the case of cellular devices, for example, the voicemail feature may be provided by the wireless carrier of the device.

In addition to enabling a user to affirmatively answer or decline an incoming call, some devices offer an optional affirmative response from the user in the form of a text-message reply. With this feature, a user may affirmatively decline to answer an incoming call, but at the same time text-message the caller back with a short text-message.

Rather than limiting the user to either answering or declining an incoming call, one or more embodiments described herein enable an incoming call to be programmatically answered and acted upon in a manner that is customized or personalized by the user. In one embodiment, the user may customize or personalize an alternative call handling routine to accommodate a specific situation or event, a specific person (e.g. spouse), or a class of persons (e.g. family members). Step 115 provides that a determination is made as to the call handling routine that is to be initiated. Under an embodiment, the determination may be based on whether a default call handling routine is to be superseded by one or more alternative call handling routines. In one embodiment, the determination of step 115 may be based on a source of the incoming call. For example, data associated with the incoming call may be used to determine the identity of the person placing the incoming call.

As an alternative or addition, an embodiment provides that the specific call handling routine that is used for a given incoming call is event-based. In particular, an alternative call handling routine may be initiated in response to an event that corresponds to the user manually selecting to have the alternative call handling routine initiated after receiving the incoming call. For example, the user may recognize the number of the incoming call, see the phone number of the caller, or assume the incoming call is from a specific individual based on the time that the call is received. One or more alternative call handling routines may be provided as an option to the user, so that the user's selection may be made with relatively simple input, such as a tap or button press.

As another variation, an alternative call handling routine may be initiated in response to other events. For example, when a user is in transit, the user may set the device to a mode of operation where all incoming calls are received with the alternative call handling routine. In such a scenario, the alternative call handling routine may answer all incoming calls with a message that provides specific information that the recipient of the call is preoccupied or in transit, and will call back at some later duration.

If the determination of step 115 is that the default call handling routine is to take place, then step 120 provides that a sequence or set of actions that comprise the default call handling routine are initiated and performed. These actions may include transferring the incoming call to voicemail, and providing the user with a notification of the missed call and/or voicemail. In general, the default call handling routine corresponds to actions that a computing device or service is capable of performing once the incoming call is received (e.g. by default setting), but for configuration or setting data or intelligence that would otherwise result in the alternative call handling routine being performed. It is possible for a device to support multiple default call handling routines that a user may pre-select (e.g. TTY handicap answering). An embodiment provides that once selected, the call handling routine is default in that the call handling routine is enabled without user action being required after the incoming call is received. The use of programmatic intelligence and data may enable deviation from the default call handling routine into the alternative call handling routine after an incoming call is received.

If the determination of step 115 is that in alternative call handling routine is to be preformed, then step 130 provides that a sequence or set of actions that comprise the alternative call handling routine are initiated and performed. As with the default call handling routine, an embodiment provides that the actions performed include programmatically answering the incoming call and playing a pre-recorded message for the caller. However, differences with the default call handling routine may exist, such as in the actions performed, in the sequence that the actions are performed, or in the manner in which the actions are performed. For example, (i) the message that is played to the caller may be different from the default call handling routine, (ii) the timing of the actions may be different (e.g. terminate call without recording message from caller or programmatically place caller on hold); and/or (iii) the sequence of actions that are performed may differ. Still further, the alternative call handling routine may include one or more actions that are not performed with the default call handling routine. As an example, an action may include recording a message from the caller on the device, or altering the mode of operation of the device. Still further, another example includes placing the caller on hold.

According to an embodiment, more than one alternative call handling routine may be used by one user. For example, a specific outgoing message may be specified under the alternative call handling routing for a specific individual, and the alternative call handling routine may play different messages for different callers.

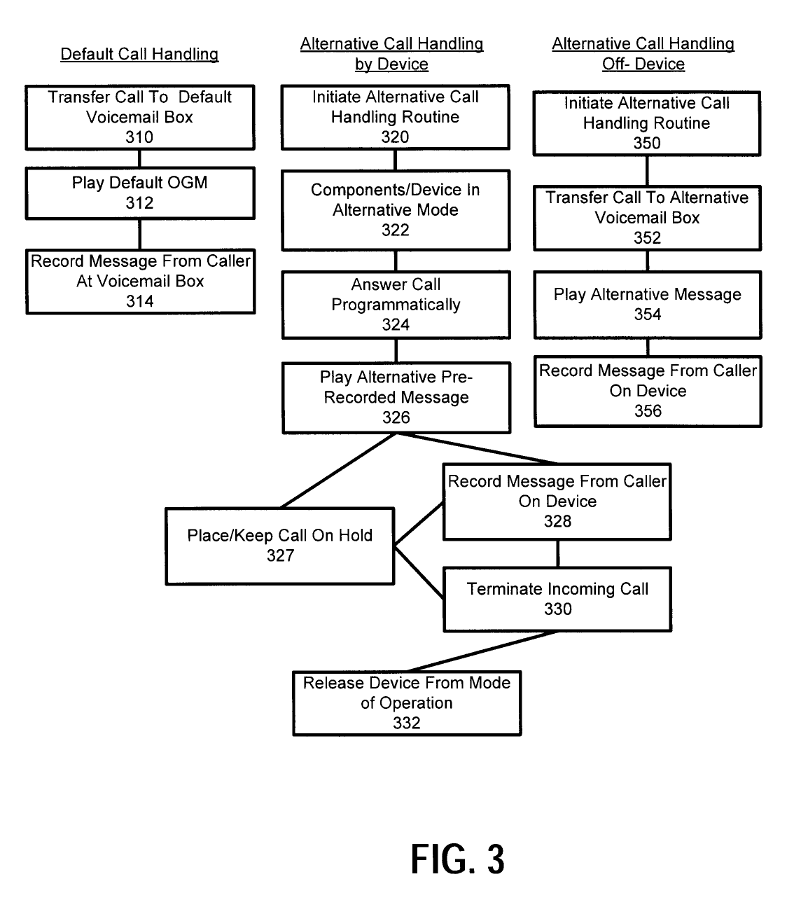

Additionally, the actions performed by an alternative call handling routine may be based on implementation and/or user-configuration. In one embodiment, the actions performed and the manner in which the actions are performed for a given alternative call handling routine may be specified by the user. For example, not only may the user specify a specific message for different individuals for use with the alternative call handling routine, but in some cases, the user may elect to have the alternative call handling routine terminate a call after playing the outgoing message without recording a message from the caller. In other cases, the user may specify to have the alternative call handling routine be enabled to record a message from the caller. FIG. 3 lists examples of actions that may be performed by call handling routines under one or more embodiments.

Device Implementation

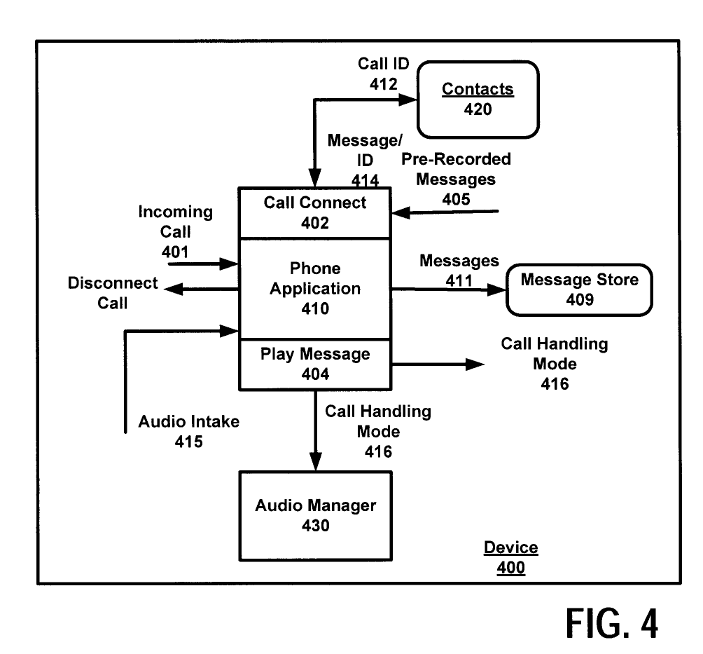

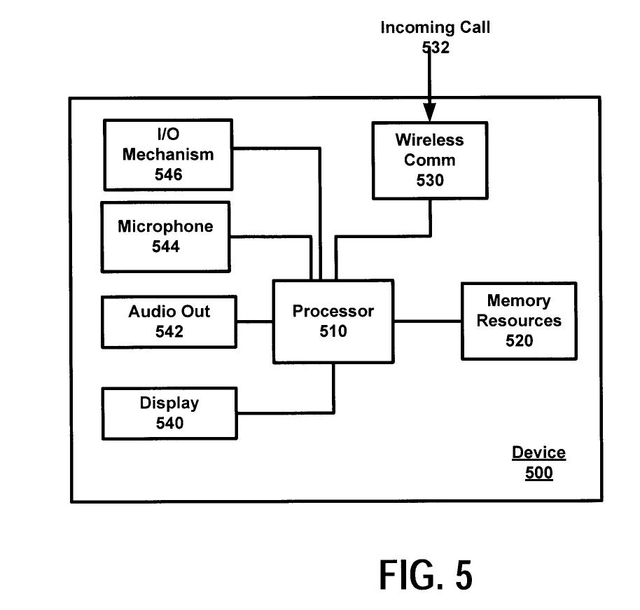

FIG. 2 illustrates a method for enabling alternative call handling routines to be performed on a device, under an embodiment of the invention. In one embodiment, a method such as described may be performed on a mobile computing device that uses wireless communications (e.g. cellular) to receive and conduct telephony. A method such as described may be performed by devices such as described with embodiments of FIG. 4 and FIG. 5.

Step 210 provides that an incoming call is received on a device. For example, a call connect request may be made through a cellular network to a cellular telephony device.

In step 220, the determination is made that the incoming call is to receive an alternative call handling routine (as opposed to a default call handling routine). The determination may be made programmatically, or triggered through user input. Sub-step 222 provides that the determination may be made based on extracting data or information from the incoming call, such as the caller-identification information that is provided with the incoming call. In an embodiment, the caller-identification information is cross-referenced to contact information that is stored on the device. The contact information may include designations that specific contacts are to be provided alternative call handling routines when they make a call.

As an alternative or addition, sub-step 224 provides that the alternative call handling routine may be triggered by manual input from the user. For example, the user may be provided a manual option to implement an alternative call handling routine for any incoming call.

As another alternative or addition, sub-step 226 provides that the alternative call handling routine may be triggered by another event or condition (other than manual input). As another example, calendar event or a mode designation from the user may be used to at least partially determine whether the alternative call handling routine is to take place. For example, one of multiple possible alternative call handling routines may be implemented when a user's calendar program indicates that the user is at a meeting or appointment.

In one embodiment, the alternative call handling is triggered by a combination of (i) an event corresponding to the user not answering or delaying answer to an incoming call, and (ii) programmatic determination that the incoming call is pre-selected to receive the alternative call handling routine.

In step 230, the alternative call handling routine is performed. Different actions or operations may comprise the alternative call handling routine, depending on implementation and/or configuration. In an embodiment in which the alternative call handling routine is at least partially performed on the device receiving the incoming call, one or more actions that comprise the alternative call handling routine are performed on the device. These may include, for example, answering or connecting to the incoming call and disconnecting from the call. As described with an embodiment of FIG. 3, the actions that comprise the alternative call handling routine differ in at least some respects from the default call handling routine.

Sub-step 232 provides that the alternative call handling routine includes a sequence of actions, including at least one action that differs from a default call handling routine. An embodiment of FIG. 3 lists different actions that may be performed in the sequence of providing an alternative voicemail or voice-greeting function for select sources of incoming calls. These may include one or more of (i) answering the incoming call (on the device), (ii) playing the incoming caller a greeting that is personalized for that caller, (iii) terminating the call with or without recording a message from that person. Other actions that may be performed include timing the call-pickup. For example, as a matter of convenience, an embodiment may provide that that the call-pickup occurs on the first ‘ring’ when the alternative call handling routine is initiated, for the convenience of the caller.

In one embodiment, sub-step 234 provides that the alternative call handling routine includes temporarily changing the mode of operation of the device, or one or more components of the device. Such a change in the mode of operation of the device or its components enables the device to perform functions such as connect to the call (i.e. answer the incoming call), play an outgoing message and/or record an incoming message. As an example of what can be altered with a mode change, the microphone and speaker of the device may be disabled while the alternative call handling routine takes place. This avoids the user of the device from hearing an outgoing message, or from hearing the recorded message. Likewise, the microphone may be shut-off to prevent the device from enabling the caller to hear the user.

As an alternative or addition, the device as a whole may change modes to enable the speaker/microphone to be disabled, and/or to disable other actions that the user may inadvertently perform that would otherwise disrupt the performance of the alternative call handling routine. These include disabling button input, precluding other outgoing calls, and/or precluding the user from turning the wireless radio off while the alternative call handling routine takes place.

As an optional step of performing the alternative call handling routine, sub-step 236 includes alternating the call-answer location from the location where the default voicemail operates. For example, if the default voicemail feature of a device operates as a service, the alternative call handling routine may provide that the call-pickup occurs on the device. Alternatively, the call-pickup may occur at a different voicemail service, or at a different voicemail box with the same service.

In addition to providing an alternative call-pickup location, an embodiment may provide for transferring other actions or steps of the alternative call handling routine from the device to a service or other remote location. For example, as described with an embodiment of FIG. 3, the recorded message may be stored temporarily on the device then transferred to a service for retrieval.

FIG. 3 compares actions or sequence of actions that may be performed under a default call handling routine, a device-based alternative call handling routine, and a service-based alternative call handling routine, under one or more embodiments of the invention. With regard to the default call handling routine, typical actions that may be performed are provided by steps that include: (i) step 310—transfer call to remote service of voicemail box (either through the user affirmatively declining to answer the incoming call or by the call being passed to the voicemail box because of device state or non-answer after set duration of time); (ii) step 312—play standard or default outgoing message, with option to enable the caller to bypass the greeting or page the person being called; (iii) record message from the caller at the service or network location of the user's voicemail box. As mentioned, the caller may sometimes be able to bypass the voicemail box and request to page the device user, in which case some form of notification may be communicated to the device user.

In contrast to a default call handling routine, an embodiment provides that an alternative call handling routine includes one or more actions that are personalized for the source of the incoming call. In an embodiment, the alternative call handling routine includes one or more actions that are not performed by the default call handling routine.

Steps 320-332 illustrate one or more alternative call handling routines that may be performed at least substantially on the device that receives the incoming call. In particular, steps 320-332 illustrate at least some of the actions or combinations of actions that may be performed when the device-based alternative call handling routine takes place. Only some of the steps discussed and illustrated in steps 320-332 are required to be performed to comprise the alternative call handling routine. While the numbering and presentation of the steps suggest a sequence, other implementations may vary the order in which one or more steps are performed, at least as compared to the illustrated embodiments. Additionally, one or more embodiments provide that the device-based alternative call handling routine includes one or more actions that are either (i) not performed with the default call handling routine, or (ii) performed differently than a corresponding action of the default call handling routine.

In a step 320, the alternative call handling routine is initiated. This may be done automatically, or initiated with manual participation of the user. When automatic, an embodiment provides that a source of an incoming call is recognized and the alternative call handling routine is initiated. The user may designate a device mode of operation where the alternative call handling routine is initiated automatically for select sources of incoming calls. As mentioned, the sources of the incoming call may be recognized from data associated with the incoming call, data stored about contacts or sources of incoming calls on the device, or a combination thereof.

Manual initiation of the alternative call handling routine may include the user providing a trigger input to initiate the alternative call handling routine. For example, the user of the device may be prompted the option each time an incoming call is received. The user may enter a button press or screen-tap to trigger or initiate performance of the alternative call handling routine.

The other events or conditions may also trigger the performance of the alternative call handling routine, in response to an incoming call. For example, rather than user-input, the alternative call handling routine may be used when the user designates a quiet mode on the device.

As mentioned with an embodiment of FIG. 2, step 322 provides that one or more components of the device (or the device itself) may change mode of operation, so as to not interfere with performance of a remainder of the alternative call handling routine. For example, the speaker and microphones of the device may shut-off, and the display of the device may indicate that the device is performing the alternative call handling routine.

In step 324, the call is answered programmatically on the device. In step 326, a pre-selected and/or recorded outgoing message is played back once the incoming call is answered. Thus, for example, the incoming call is answered and greeted with an outgoing message that is pre-selected for the particular source (e.g. spouse) or class of the source of the incoming call (e.g. ‘family’).

Step 328 provides that the caller is provided an opportunity to record a message for the user of the device. Such a step may simulate traditional voicemail operation, except under one embodiment, the operation of recording the message is performed on the device without transferring the call to a voicemail box.

Subsequent to the message of the caller being recorded, step 330 provides that the incoming call is terminated. The device may hang-up, or respond to the source of the incoming call terminating the session. As an alternative, however, the incoming call may be terminated automatically on the device once the pre-selected outgoing message is played back (i.e. following step 326). For example, the device may play a pre-record message that states “I will call you back as soon as I can, running late” (step 326) then terminate the call without enabling the caller to leave a voice message. Such an implementation avoids the device having to record voicemail messages, which can consume device memory and other resources.

Following termination of the incoming call, an embodiment provides that in step 332, the device is released from its mode of operation for the alternative call handling routine. For example, speaker and microphone functionality may be returned. Other configurations made specific for the alternative call handling routine may be terminated (e.g. display screen, buttons).

In one embodiment, the device is configured to record a message from the caller, and then transfer the message to a remote location (step 334). The remote location may include any one of the following, depending on implementation or embodiment employed: (i) transfer to the default voicemail box; (ii) transfer to another voicemail box; (iii) transfer to an email inbox; or (iv) transfer to any network or remote folder where files are accessible to the user. With transfer, the message recorded on the device may be deleted either automatically or at the initiative or pre-selection of the user.

Any mode of transfer may be used to transfer the recorded message from the device to the remote location. For example, the recorded message may be streamed to a network location, or messaged via a messaging protocol (POP3 email, Multimedia Message Service (MMS)). Still further, the recorded message may be converted into text by a speech-to-text application, which then sends the text file via messaging to another location.

According to an embodiment, when a user receives a recorded message as a result of performance of the alternative call handling routine, a notification may be communicated to the user via the device that received the incoming call.

As an alternative or addition to recording a message (step 328) from the caller and terminating the call (step 330), an embodiment provides for a step 327 of placing the incoming call on hold, or in a hold-like state, so that the call remains connected. In the hold-like case, for example, the ability of the receiving device's microphone to transmit for the call may be disabled. This step may occur immediately when the call is answered (step 324) or after a message is played to the caller (step 326). Rather than terminate the call, an embodiment provides that the call connect is maintained, and the user is played a message that indicates the user will be on the call shortly. An implementation may enable the caller to terminate or record a message rather than wait, or provide the caller with that option after a designated duration.

Steps 350-358 illustrate steps of a service-based alternative call handling routine, under an embodiment of the invention. The service-based alternative call handling routine may be performed by, for example, a carrier or other service provider of a cellular device.

In step 350, once the alternative call handling routine is initiated, the incoming call is transferred to a remote location where subsequent actions may be performed. Step 352 provides that the call is answered. Step 354 provides that a pre-selected outgoing message is played for the caller, where the outgoing message is pre-selected for that caller as an individual or by class.

Step 356 enables the caller to record a message. A service may more readily enable the feature of enabling the message to be recorded, as more memory and other resources can be provided. Step 358 provides that a notification is sent to the caller that the alternative call handling routine recorded a message for an incoming call (e.g. identify caller), as well as whether the caller recorded a message for the user. As an alternative to sending the notification, the recorded message may be transferred to the device. As another alternative, the recorded message may undergo speech-to-text conversion and then transferred to the device or otherwise messaged to the user of the device.

While embodiments of FIG. 3 illustrate alternative call handling routines that can be performed substantially on either the device or by a service, one or more embodiments include implementation of an alternative call handling routine that includes actions performed on both device and service. For example, the alternative call handling routine may be initiated on the device by the device recognizing the caller, and then transferring the call to the service of the alternative call handling routine.

Device Description

FIG. 4 illustrates a computing device configuration for enabling an alternative call handling routine such as described with any of the embodiments described herein, according to another embodiment of the invention. In an embodiment, a device 400 includes a phone application 410, a contact memory store 420, and an audio manager 430. Each of the application, store and manager may be separate or integrated programmatic elements or modules. In an embodiment, a call connect feature 402 is integrated or otherwise provided in connection with the phone application 410. Likewise, a play message feature 404 may be integrated or otherwise provided with the phone application 410.

The contact memory store 420 may correspond to a collection of contact records for the user of the device. The records may include name and phone numbers of individuals, as well as message identifiers used by individual persons. According to an embodiment, a user of the device 400 is able to pre-designated data with individual contact records as to who is to receive a personalized alternative call handling routine. Still further, an embodiment provides that the user of device 400 is able to record an outgoing message for an individual contact, and associate that message with the contact in the event the person identified by the contact places the incoming call 401.

In one embodiment, pre-recorded messages 405 are stored for use with individual contacts in the contact store 420. The pre-recorded messages 405 may be stored in or with individual contact records when made specific for a specific contact or class of contacts. Alternatively, a message store may store one or more pre-recorded messages 405 for events (e.g. “hold on, I'll be on the call in a minute”) which may include actions such as answer and hold. In such an instance, the pre-recorded message 405 may not be specific to the contact, but may be used anytime the alternative call handling event is performed or performed in response to a specific event. A message store may also store pre-recorded messages 405 that are for both events and contacts (e.g. specific to spouse and event). Numerous other variations and implementations exist by which the user of the device 400 may record and associate personalized messages for the alternative call handling routine on the device.

The call connect feature 402 may respond to an incoming call 401, and include programmatic elements for extracting data associated with the incoming call 401. This data may correspond to caller-identification information, which may include the name of the caller and/or phone number of the caller. The call connect feature 402 may access the contact memory store 420 to compare the caller-identification information 412 with information stored or associated with individual records. As a result of the comparison, either a message identifier 414 or the actually outgoing message (for use with the alternative call handling routine) is returned for use by the play message feature 404.

The play message feature 404 may instruct 416 or request the audio manager 430 to implement the message playback actions of the alternative call handling routine. The instruct 416 may also be used to notify other devices (or the processor) to alter the mode of operation to enable the alternative call handling mode. The audio manager 430 may use the message identifier or pre-recorded message 405 (for the particular source of the incoming call 401) to playback a pre-recorded message 407 for a contact, or in response to a particular event. Additionally, the audio manager 430 may implement a mode of operation in which the audio playback is communicated through the data channel of the device to the network, without playback being heard on the device itself. Thus, the mode may be implemented where the speaker of the device is shut-off.

In an embodiment, the phone application 410 may manage audio intake 415 when the caller records a message. A record message store 409 may be used to hold messages on the device when the caller records a message as part of the alternative call handling routine. Additionally, an embodiment provides that the record message store 409 may be made accessible or usable with messaging or transfer applications 411 that can transfer each recorded message off the device and to a remote location.

FIG. 5 illustrates a hardware diagram for a mobile computing device that is configured to support any of the embodiments described herein. A mobile computing device 500 may correspond to any device that includes roaming wireless network and/or telephony capabilities, including cellular telephony devices and/or mobile messengers. In particular, embodiments described herein may apply to numerous kinds of mobile or small form-factor computing devices. One type of mobile computing device that may be configured to include embodiments described herein includes a computer telephony device, such as a cellular phone or mobile device with voice-telephony applications (sometimes called “smart phone”). A computing device such as described may be small enough to fit in one hand, while providing cellular telephony features in combination with other applications, such as messaging, web browsing, media playback, personal information management (e.g. such as contact records management, calendar applications, tasks lists), image or video/media capture and other functionality. Mobile computing devices in particular may have numerous types of input mechanisms and user-interface features, such as keyboards or keypads, multi-directional or navigation buttons, application or action buttons, and contact or touch-sensitive display screens. Some devices may include combinations of keyboard, button panel area, and display screen (which may optionally be contact-sensitive) on one facade. The button panel region may occupy a band between the keypad and the display area, and include a navigation button and multiple application buttons or action buttons.

Specific types of messaging that may be performed includes messaging for email applications, Short Message Service (SMS) messages, Multimedia Message Service (MMS) messages, and proprietary voice exchange applications (such as SKYPE). Still further, other types of computing device contemplated with embodiments described herein include laptop or notebook computers, ultra-mobile computers, personal digital assistants, and other multi-functional computing devices.

Still further, one or more embodiments may be implemented through any type of computing device is a desktop computer that is configured to include real-time voice data exchange (e.g. through use of Internet Protocol telephony). Still further, other types of computer telephony devices exist, including standalone devices that connect directly to a telephone network (whether Internet Protocol or Public Switch Telephony System (PSTN)) and provide software interfaces and applications.

According to an embodiment, the device 500 may include one or more processors 510 (as processing resources), memory resources 520, one or more wireless communication ports 530, and various other input/output features, including a display 540, a speaker 542, a microphone 544 and other input/output mechanisms 546.

The wireless communication port 530 may receive incoming calls 532. The processor(s) 510 may respond to the incoming calls 532 by enabling call connect, call decline, voicemail transfer or an alternative call handling routine, such as described with any of the embodiments described herein. In an embodiment in which the device 500 is configured to perform some or all of the alternative call handling routine, the processor 510 may execute the phone application 410 (see FIG. 4) to connect to the incoming call 532 and to implement the actions of the alternative call handling routine.

As described with other embodiments, the processor(s) 510 may implement a mode in which various components of the device 500 are disabled. In one embodiment, when the alternative call handling routine is initiated, components that include the speaker 542, the microphone 544 and other input/output mechanisms 546 are disabled or prevented from being used by the user. The display 540 may display information about the status or progress of the alternative call handling routine, or alternatively, may be disabled or disconnected from the alternative call handling routine altogether.

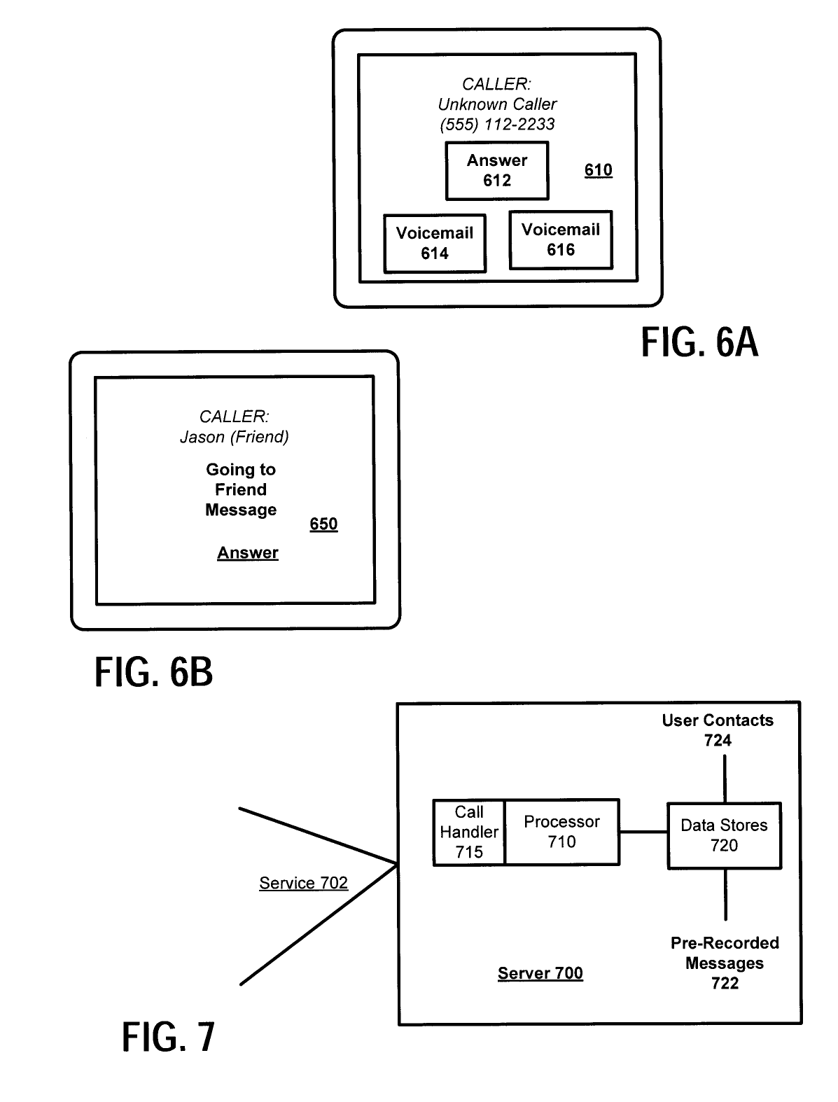

FIG. 6A and FIG. 6B illustrate different user-interface features for use with one or more embodiments of the invention. In FIG. 6A, a first user-interface 610 may be rendered on a device display 540 (FIG. 5) when an incoming call is received. The user-interface 610 may provide the user with options that invite user response. These options include an answer feature 612, as well as an option 614, 616 to enable the user to specify the incoming call is to receive either default voicemail handling or alternative call handling routine. One implementation provides that the user-interface 610 is rendered on a contact or touch-sensitive display screen, so that the user may simply tap the feature to answer the call or implement one of the call handling routines. User response to either features 614, 616 for the call handling routines may trigger the device to initiate or implement the actions that comprise the corresponding call handling routine.

The first user-interface 610 is illustrative of an embodiment in which the user is provided the ability to trigger an alternative call handling routine. Such an embodiment may be implemented anytime that the incoming caller is unknown. As an alternative, such an embodiment may be implemented as default, or in each instance when the alternative call handling routine is provided or enabled on a computing device.

In FIG. 6B, a second user-interface 650 may be rendered on the device display 540 (FIG. 5) when an incoming call is received and automatically answered with the alternative call handling routine. The display screen 540 (FIG. 5) may be used to display status information about the incoming call. As an alternative or addition, the display screen may be disabled or disconnected from performance of the alternative call handling routine, depending on the implementation of the embodiment.

While FIG. 6A and FIG. 6B illustrate user-interface features for use with embodiments, the specific functionality and appearance are only illustrative. Other functions and features may be used, such as hard-buttons, to implement any of the embodiments described herein.

Usage Scenarios

Under one implementation, a user may record, capture, or otherwise select pre-recorded greetings with short instructions or personalized invitations for close family members or friends. The individuals who are to receive the greeting may be identified on the user's device. The user may specify the individuals through input that cross-references or uses the user's contact records. Optionally, the user may record messages from those users when they call. With reference to an embodiment of FIG. 3, when pre-designated individuals call, the following actions may comprise the alternative call handling routine: (i) the call is answered automatically (step 324), (ii) the personalized messages for the caller may be played (step 326), (iii) a voice recorded messages may be recorded from the caller (step 328), (iv) the call may be terminated (step 330), and (v) optionally, the recorded message may be transferred off-device to a network location, such as a user's network file folder (step 332).

In such embodiments, a user may record several messages for different individuals, and/or enable some, but not all of the individuals selected to receive personalized messages to record messages for the user. The alternative call handling routine (with the caller-specific messages) may be employed automatically once one of the identified individuals places a call to the device. Alternatively, the user may provide an input to trigger the alternative call handling routine to be performed in response to an incoming call from a specific individual. Numerous variations are possible.

In another implementation, the user may record an alternative message for a specific purpose or event (including events where the user provides the trigger input). For example, the user may record a message for the situation where the user cannot quite pickup the phone in time. When an incoming call arrives, if the situation merits it, the user may elect to provide the trigger input (e.g. tap feature 616 of FIG. 6) and initiate the alternative call handling routine. With reference to FIG. 3, for example, the alternative pre-recorded message (step 326) may ask the caller to hold on to the call for a duration. Other actions that may performed by such an alternative call handling request may correspond to the call being answered (step 324) and placed on hold (step 327).

As another, the user may be able to record a message just prior to answering the call (e.g. “hold on”). Thus, the alternative call handling routine may be triggered by input and include an initial user-action of recording a quick voice blurb. Upon completion of the blurb, the call may be answered programmatically in the hold state, where, for example, microphone sounds from the device are not communicated on the call. The message may be played to the caller (step 326). Background music or noise may also be played until the user is able to come onto the call.

Still further, an embodiment provides that a user may specify a series or sequence of actions. In one embodiment, a user may specify that, for a given duration or setting, the device is to answer incoming calls by placing the incoming calls on hold. The incoming calls may be provided a “on hold” message that is pre-recorded or selected for the user. In addition, the user may specify that when the incoming call is from a specific person or source, that another message may be played to the caller after the caller is placed on hold. For example, the user may record a personalized, pre-recorded message for a specific individual, while at the same time, providing for incoming calls to be placed on hold. Thus, the user may chain messages or actions, depending on the event or the caller. As a specific example, a device may be set so that all incoming calls are placed on hold, with a hold message played from the user (e.g. “Be with you in a second, please hold”). In addition, if the caller is a designated person, another message may be played (e.g. “Jim, if I am not with you in a minute, lets talk tomorrow in the office”). In this way, the user may chain specific actions. In an embodiment, any of the actions recited herein, such as listed in FIG. 3, may be chained or sequenced by the user, and made condition on events or persons calling.

Still further, an embodiment provides that specific actions may be selected programmatically, based on the caller and/or events or user-input. For example, all incoming calls may receive an on-hold message, except for calls from specific individuals (e.g. spouse), who receive a personalized message and option to record voicemail, followed by programmatic call termination.

The manner in which such actions are chained or substituted for one another may be provided by a user-interface or other mechanism, to enable implementation configurations by the user.

Service Implementation

FIG. 7 illustrates a service configured to implement an alternative call handling routine, under an embodiment. In an embodiment in which a service is configured to perform the alternative call handling routine, a server 700 for a service 702 includes processing resources 710 that use memory and data stored therein to perform an alternative call handling routine for the user of the device. The service 702 may record and store in one or more data structures 720, provided for a user, the various specialized or personalized outgoing pre-recorded messages 722 that the user wishes to provide for contacts 724 and/or events.

Similar to an embodiment of FIG. 4, an embodiment of FIG. 7 provides that the user-contacts 724 are stored as part of the data structure(s) 720 and associated with a particular user. Pre-recorded messages 722 from that user may be stored in association with individual contact records, and/or stored for specific events. Much like operation of the device's phone application 410 (FIG. 4), a corresponding call handling component 715 on the server may include a combination of logical and physical resources that connect to the incoming calls (such as after they are transferred from the device to the server). The call handling component 715 may perform the alternative call handling routine as part of a service. Actions such as described with an embodiment of FIG. 3 may be performed as part of the services alternative call handling routine functionality.

It is contemplated for embodiments described herein to extend to individual elements and concepts described herein, independently of other concepts, ideas or system, as well as for embodiments to include combinations of elements recited anywhere in this application. Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. This, the absence of describing combinations should not preclude the inventor from claiming rights to such combinations.

What is claimed is:

1. A method for handling an incoming telephony call on a computing device, the method comprising:
receiving the incoming call;
responsive to receiving the incoming call, making a determination to implement an alternative call handling routine instead of a default call handling routine; and
initiating the alternative call handling routine by performing a set or sequence of one or more actions that comprise the alternative call handling routine;
wherein but for the computing device initiating the alternative call handling routine, the computing device is capable of performing the default call handling routine without any input from the user after receiving the incoming call.

2. The method of claim 1, wherein making a determination to implement an alternative call handling routine includes:
identifying information associated with the incoming call;
using the information to identify a source of the incoming call; and
determining that the source of the incoming call is pre-selected to receive the alternative call handling routine.

3. The method of claim 1, wherein making a determination to implement an alternative call handling routine includes making the determination in response to one or more events that designates performance of the alternative call handling routine.

4. The method of claim 3, wherein making the determination in response to one or more events includes receiving an input from a user of the computing device to initiate performance of the alternative call handling routine.

5. The method of claim 4, wherein the method further comprises performing the alternative call handling routine, including playing a pre-recorded audio message for a caller of the incoming call.

6. The method of claim 2, wherein the method further comprises performing the alternative call handling routine, including playing a pre-recorded audio message for a caller of the incoming call.

7. The method of claim 6, wherein the pre-recorded audio message is specific to either (i) the caller, or (ii) a class of contact records that includes a contact record that identifies the caller, the class of contact records comprising a portion of a plurality of contact records stored on the computing device.

8. The method of claim 1, wherein initiating the alternative call handling routine includes performing a set of actions in a sequence that differs from a sequence that a corresponding set of actions are performed in the default call handling routine.

9. The method of claim 1, wherein initiating the alternative call handling routine includes performing at least one action in the set of one or more actions of the alternative call handling routine that is different than any action performed by the default call handling routine.

10. The method of claim 1, further comprising performing the alternative call handling routine by performing all of the actions in the set or sequence that comprise the alternative call handling routine, including answering the incoming call.

11. The method of claim 10, wherein performing the alternative call handling routine includes playing an alternative outgoing message that is different than an outgoing message played with the default call handling routine.

12. The method of claim 11, wherein performing the alternative call handling routine includes recording a message from a caller of the incoming call.

13. A method for handling an incoming telephony call, the method comprising:
identifying information about a source of an incoming call that is made to a user;
determining, from the information, that the source is one of at least one pre-selected set of sources that are to receive an alternative call handling routine;
responsive to determining that the source of the incoming call is one of the pre-selected set of sources, initiating performance of the alternative call handling routine;
wherein initiating the alternative call handling routine includes performing at least one action in a set of one or more actions that comprise the alternative call handling routine;
wherein at least one action in the set of one or more actions of the alternative call handling routine is different than any action performed by a default call handling routine that would have otherwise been performed had the source of the incoming call not been one of the pre-selected set.

14. The method of claim 13, wherein performing at least one action in the alternative call handling routine includes prompting the user to select to have one or more subsequent actions in the alternative call handling routine subsequently performed.

15. The method of claim 13, wherein initiating the call handling routine includes automatically performing each action in the set of one or more actions responsive to determining that the source of the incoming call is one of the pre-selected set of sources.

16. The method of claim 13, further comprising performing the alternative call handling routine, including (i) answering the incoming call, and (ii) playing an alternative outgoing message, wherein the alternative outgoing message is different than an outgoing message played with the default call handling routine.

17. The method of claim 16, wherein performing the alternative call handling routine further comprises recording a message from a caller of the incoming call.

18. The method of claim 16, wherein performing the alternative call handling routine includes automatically hanging up on the incoming call after playing the alternative message.

19. The method of claim 13, wherein performing the alternative call handling routine includes automatically hanging up on the incoming call after detecting that the caller has recorded the message.

20. The method of claim 13, further comprising transferring the recorded message to a remote location for storage and/or access by the user.

21. The method of claim 13, wherein determining that the source is one of at least one pre-selected set of sources includes identifying a phone number used by a caller that corresponds to the source, and referencing the phone number to a specific contact record that is in a contact record database of the user.

22. The method of claim 13, wherein the method is performed on a mobile device that receives the incoming call over a cellular or wireless network.

23. The method of claim 13, wherein the incoming call is placed over a cellular network, and wherein the method is performed by a service associated with the cellular network and remote from the device on which the incoming call is received.

24. The method of claim 13, further comprising:
programmatically precluding use of one or more user-interface features while initiating or performing the alternative call handling routine.

25. The method of claim 24, wherein programmatically precluding use of one or more user-interface includes precluding audio output.

26. The method of claim 24, wherein programmatically precluding use of one or more user-interface includes disabling one or more input mechanisms that would otherwise be operable to disrupt the incoming call or the alternative call handling routine.

27. A mobile computing device comprising:
one or more communication components for handling telephony communications over one or more networks;
one or more processors configured to respond to an incoming call received from over a network by:
determining whether the incoming call is to receive a default call handling routine or an alternative call handling routine;
responsive to determining that the incoming call is to receive the default call handling routine, enabling the incoming call to be answered by a default voicemail function that plays a default outgoing message;
else, responsive to determining that the incoming call is to receive the default call handling routine, performing at least one action in a set of one or more actions that comprise the alternative call handling routine, including at least one action that is not performed in the default call handling routine.

28. The mobile computing device of claim 27, wherein the one or more processors are configured to determine whether the incoming call is to receive the default handling routine or the alternative call handling routine by using data associated with the incoming call to determine that a source of the incoming call is pre-selected to receive the alternative incoming call routine.

29. The mobile computing device of claim 27, wherein the one or more processors are configured to determine whether the incoming call is to receive the default handling routine or the alternative call handling routine by receiving an input from the user that selects the incoming call is to receive the alternative call handling routine.
